(19) United States
(12) Patent Application Publication
(10) Pub. No.: US 2023/0057417 A1
(43) Pub. Date: Feb. 23, 2023

(54) SEPARATOR FOR FUEL CELL

(71) Applicants: Hyundai Motor Company, Seoul (KR); Kia Corporation, Seoul (KR)

(72) Inventors: Byung Gun Song, Seongnam (KR); Jin Hyeok Yoo, Yongin (KR); Sun Do Shin, Yongin (KR)

(21) Appl. No.: 17/729,696

(22) Filed: Apr. 26, 2022

(30) Foreign Application Priority Data
Aug. 18, 2021 (KR) 10-2021-0108983

(51) Int. Cl. H01M 8/0258; H01M 8/04029

(52) U.S. Cl. CPC H01M 8/0258; H01M 8/04029; H01M 2250/20

(57) ABSTRACT

Disclosed is a separator for a fuel cell. The separator includes a separator main body formed in a plate shape such that a first surface thereof forms a reaction surface and a second surface thereof forms a cooling surface, each of which has a reaction area at a center portion thereof and formed with multiple manifold areas through which multiple manifolds to which a reaction gas or a coolant is respectively introduced or discharged pass to opposite sides of the reaction area, and in which a pair of diffusion areas that diffuse the reaction gas or the coolant are formed between the reaction area and the pair of manifold areas, and includes multiple flow path guide gaskets formed on the pair of diffusion areas and configured such that multiple diffusion flow paths dispersed to the reaction area from at least a pair of the manifolds respectively formed on the pair of manifold areas are formed.

### CROSS REFERENCE TO RELATED APPLICATION

The present application claims priority to Korean Patent Application No. 10-2021-0108983, filed Aug. 18, 2021, the entire contents of which is incorporated herein for all purposes by this reference.

### TECHNICAL FIELD

The present invention relates to a separator for a fuel cell. Particularly, the separator as provided herein is capable of preventing a shape thereof from being deformed at a diffusion area caused by flow pressure of a coolant.

### BACKGROUND

A fuel cell is a type of power generator for converting chemical energy contained in fuel into electrical energy by electrochemically reacting in a stack, and may not only supply driving power for industry, homes, and vehicles but also may be used for supplying the power of small electronics such as a portable device. Further, in recent years, the use region of the fuel cell is gradually expanding to a high-efficiency clean energy source.

A typical fuel cell stack has a membrane electrode assembly (MEA) located at the innermost portion thereof. The MEA includes a polymer electrolyte membrane capable of transporting hydrogen protons, and catalyst layers, that is, an anode and a cathode, applied on opposite surfaces of the polymer electrolyte membrane so that hydrogen and oxygen may react.

In addition, gas diffusion layers (GDLs) are laminated outside of the MEA where the anode and the cathode are located, and separators each having a flow field for supplying fuel and discharging water generated by reactions in the MEA are respectively located outside of the GDLs. Further, end plates are assembled to the outermost portion of the MEA to structurally support and secure individual components described above in position. At this time, gaskets are formed in various patterns to maintain an airtightness of hydrogen and oxygen (air) flowing in the separators.

Meanwhile, the separators have been generally manufactured such that lands serving as supports and channels (flow field) serving as flow paths of a fluid are alternately repeated.

For example, a typical separator has a structure in which lands and channels are alternately repeated in a serpentine configuration. Because of this, a channel on one side of the separator, which faces the GDL, has been utilized as a space through which a reaction gas such as hydrogen or air flows, while a channel of the other side is utilized as a space through which a cooling material such as a coolant flows. Accordingly, one unit cell may be formed of total two separators that are one separator with hydrogen/coolant channel and one separator with air/coolant channel.

FIG. 1 is a view illustrating a conventional separator, and FIG. 2 is a cross-sectional view illustrating a reaction area of the conventional separator.

As illustrated in FIG. 1, in a center portion of a conventional separator 10, the MEA and the GDL are laminated, so that a reaction area 10a on which air and hydrogen that are reaction gases react is formed. In opposite sides of the reaction area 10a, a pair of manifold areas 10b through which multiple manifolds 11a to 11f to which the reaction gas or the coolant is respectively introduced or discharged pass are formed. In addition, between the manifold areas 10b and the reaction area 10a, a pair of diffusion areas 10c configured to diffuse a flow of the reaction gas or the coolant are formed.

At this time, the multiple manifolds 11a to 11f formed on the manifold areas 10b are classified into the manifolds 11d and 11c to which hydrogen that is the reaction gas is introduced or discharged, the manifolds 11a and 11f to which air that is the reaction gas is introduced or discharged, and the manifolds 11b and 11e to which the coolant is introduced or discharged.

In addition, a sealing line L that surrounds the reaction area 10a and each of the manifolds 11a to 11f is formed.

In addition, in the pair of diffusion areas 10c, multiple diffusion flow paths 13a are formed. The multiple diffusion flow paths 13a are configured to allow the reaction gas and the coolant introduced from the manifolds 11a, 11d, and 11e at inlet sides to be diffused and flow to the reaction area 10a, and configured to allow the reaction gas and the coolant discharged from the reaction area 10a to be collected and flow to the manifolds 11b, 11c, and 11f at outlet sides.

At this time, the diffusion flow paths 13a are formed such that lands 12a and channels 12b are formed by bending the diffusion areas 10c, and the channels 12b formed by bending becomes the diffusion flow paths 13a to which the reaction gas passes.

In particular, a first surface of the separator 10 forms a reaction surface 10A and a second surface of the separator 10 form a cooling surface 10B. Therefore, as illustrated in FIG. 2, a pair of separators 10 and 20 are disposed to be facing each other, and cooling surfaces 10B and 20B of each separators 10 and 20 are disposed to be facing each other. At this time, one of the pair of separators 10 and 20 is a cathode separator 10 and the other is an anode separator 20.

Therefore, reaction gas diffusion flow paths 13a and 23a to which the reaction gas flows are formed by lands 12a and 22a that respectively protrude from a surface of the cathode separator 10 and a surface of the anode separator 20 to each reaction surfaces 10A and 10B. In addition, in the cooling surface 10B of the cathode separator 10 and the cooling surface 20B of the anode separator 20, coolant flow paths 13b and 23b are formed by the lands 12a and 22a and the channels 12b and 22b. Further, the coolant flows to the coolant flow paths 13b and 23b, and flows through a space between the cooling surface 10B of the cathode separator 10 and the cooling surface 20B of the anode separator 20.

Meanwhile, as illustrated in FIG. 2, the reaction gas flow paths 13a and 23a to which the reaction gas flows and the coolant flow paths 13b and 23b to which the coolant flows are formed by a bent shape of the lands 12a and 22a and the channels 12b and 22b that are formed on the separators 10 and 20.

Accordingly, while the coolant flows with a predetermined pressure between the cathode separator 10 and the anode separator 20, the pressure is applied to the coolant flow paths 13b and 23b, and a problem that the pressure pushes the separators 10 and 20 toward the reaction gas diffusion flow paths 13a and 23a occurs.

When the problem that the separators 10 and 20 are deformed in a direction of the reaction surfaces 10A and 20A by flow pressure of the coolant occurs, distributivity of the coolant and the reaction gas is deteriorated. Accordingly, a problem that voltage stability and airtightness are deteriorated occurs.

The foregoing is intended merely to aid in the understanding of the background of the present invention, and is not intended to mean that the present invention falls within the purview of the related art that is already known to those skilled in the art.

### SUMMARY OF THE INVENTION

In preferred aspect, provided is a separator for a fuel cell, in which a flow path that allows a reaction gas and a coolant to be diffused is formed on a surface of a separator main body by using a gasket formed of a rubber material, thereby the separator being capable of preventing the separator main body from being deformed at a diffusion area caused by flow pressure of the coolant.

In an aspect, provided is a separator for a fuel cell, and the separator includes (i) a separator main body formed in a plate shape such that a first surface thereof forms a reaction surface and a second surface thereof forms a cooling surface, the separator main body having a reaction area at a center portion thereof, the separator main body formed with multiple manifold areas through which multiple manifolds to which a reaction gas or a coolant is respectively introduced or discharged pass to opposite sides of the reaction area, and the separator main body in which a pair of diffusion areas allowing the reaction gas or the coolant to be diffused are formed between the reaction area and the pair of manifold areas; and (ii) multiple flow path guide gaskets formed on the pair of diffusion areas and configured such that multiple diffusion flow paths that are spread out to the reaction area from at least a pair of the manifolds that are respectively formed on the pair of manifold areas are formed.

The flow path guide gaskets may be formed on the pair of diffusion areas among the reaction surface of the separator main body, and may include multiple flow path guide gaskets for the reaction gas formed between the reaction area and one of the manifold to which the reaction gas is introduced among the multiple manifolds and formed between the reaction area and one of the manifold to which the reaction gas is discharged among the multiple manifolds.

The diffusion areas of the separator main body may be formed to be flat, and the flow path guide gaskets may be formed on the pair of diffusion areas among the cooling surface of the separator main body, and may further include multiple flow path guide gaskets for the coolant formed between the reaction area and one of the manifold to which the coolant is introduced among the multiple manifolds and formed between the reaction area and one of the manifold to which the coolant is discharged among the multiple manifolds.

The flow path guide gaskets for the reaction gas and the flow path guide gaskets for the coolant may be continuously formed from the manifolds to the reaction area, respectively.

At the diffusion areas of the separator main body, multiple coolant channels that protrude toward the reaction surface and forms a groove shape may be formed between the reaction area and one of the manifold to which the coolant is introduced among the multiple manifolds and may be formed between the reaction area and one of the manifold to which the coolant is discharged among the multiple manifolds, thereby allowing the coolant to flow toward the cooling surface.

The coolant channels may be continuously formed from the manifolds to which the coolant is introduced or discharged to the reaction area, respectively, and the flow path guide gaskets for the reaction gas may be respectively formed from the manifolds to the reaction area and may be discontinuously formed at portions that are in contact with the coolant channels.

A formation height of the flow path guide gaskets for the reaction gas may be greater than a formation height of the coolant channels.

The flow path guide gaskets may be formed by injecting a rubber material on a surface of the separator main body.

On the surface of the separator main body, a sealing gasket may be formed by injecting the rubber material such that a sealing line is formed by surrounding the reaction area and each of the manifolds. In particular, the sealing gasket and the flow path guide gaskets may be formed by injecting the same type of the rubber material.

The sealing gasket and the flow path guide gaskets may be formed of ethylene propylene diene monomer (EPDM) or fluoro elastomers.

According to various exemplary embodiments of the present invention, by using the rubber material on the diffusion areas of the separator main body such that the flow path guide gaskets can be formed on the surface of the separator main body, a forming process of the separator main body can be minimized. Accordingly, an effect of preventing a shape of the separator main body from being deformed at the diffusion areas by the flow pressure of the coolant may be realized.

In addition, since the deformation of the separator main body may be prevented, a surface pressure distribution of the reaction surface may be evenly maintained.

In addition, by the flow path guide gaskets, the flow paths to which the reaction gas and the coolant are diffused may be secured directly, so that diffusivity of gas flow may be improved.

In addition, since a shape of the flow path guide gaskets is not limited to a shape of the separator main body and is freely designed, design freedom of the manifolds may be improved.

### BRIEF DESCRIPTION OF THE DRAWINGS

The above and other objectives, features, and other advantages of the present invention will be more clearly understood from the following detailed description when taken in conjunction with the accompanying drawings, in which:

FIG. 1 shows a conventional separator;

FIG. 2 shows a diffusion area of the conventional separator;

FIG. 3A shows a reaction surface of an exemplary separator for a fuel cell according to an exemplary embodiment of the present invention;

FIG. 3B shows a cooling surface of an exemplary separator for the fuel cell according to an exemplary embodiment of the present invention;

FIG. 4 shows a cross-sectional view illustrating a diffusion area of an exemplary separator for the fuel cell according to an exemplary embodiment of the present invention;

FIG. 5A shows the reaction surface of an exemplary separator for the fuel cell according to an exemplary embodiment of the present invention;

FIG. 5B shows the cooling surface of an exemplary separator for the fuel cell according to an exemplary embodiment of the present invention;

FIG. 6A shows a cross-sectional view illustrating the diffusion area of an exemplary separator for the fuel cell according to an exemplary embodiment of the present invention; and

FIG. 6B shows a partial cross-sectional perspective view illustrating the diffusion area of an exemplary separator for the fuel cell according to an exemplary embodiment of the present invention.

### DETAILED DESCRIPTION

Hereinafter, embodiments of the present invention will be described in detail with reference to the accompanying drawings. However, the present invention is not limited to the embodiments disclosed below and will be embodied in different forms which differ from each other, and these embodiments merely make the disclosure of the present invention complete and provide for fully informing the scope of the disclosure to those skilled in the art. In the drawings, like reference numerals refer to like elements.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Provided herein is a separator for increasing diffusivity of a reaction gas or a coolant while preventing a deformation of a separator main body at a diffusion area that is formed to diffuse and introduce the reaction gas or the coolant to a reaction surface. Further, the separator may be applied to various shapes of separators in which the diffusion area is formed. For example, the separator may be applied to a flow path type separator in which various shapes of flow paths are formed on the reaction area, or may also be applied to a porous type separator in which pores are additionally disposed on the reaction area. In addition, a shape and a disposing position of a manifold are not limited to a specific structure, and may be applied to all various shapes of separators in which the diffusion area is formed between the manifold and the reaction area.

Also provided is a cathode separator in which air as the reaction gas is induced to flow is exemplified and described. The separator for the fuel cell according to an exemplary embodiment of the present invention is not limited to the cathode separator, and the technical idea of the present invention may also be applied to an anode separator.

Hereinafter, in the separator for the fuel cell according to various exemplary embodiments of the present invention, the cathode separator is exemplified and described.

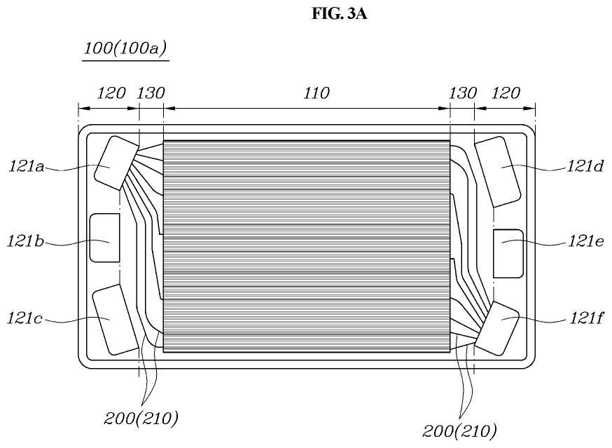

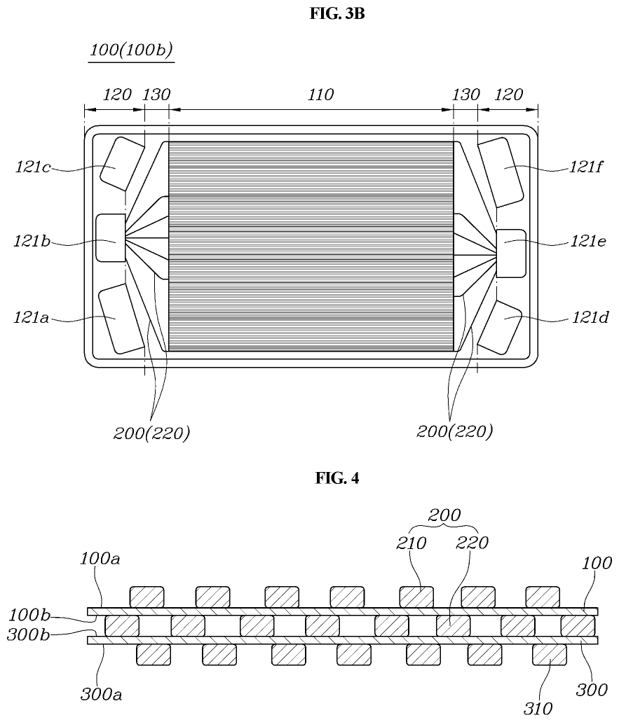

FIG. 3A is a view illustrating a reaction surface of a separator for a fuel cell according to an exemplary embodiment of the present invention, FIG. 3B is a view illustrating a cooling surface of the separator for the fuel cell according to an exemplary embodiment of the present invention, and FIG. 4 is a cross-sectional view illustrating a diffusion area of the separator for the fuel cell according to an exemplary embodiment of the present invention.

As illustrated in drawings, the separator for the fuel cell a includes a separator main body 100 and multiple flow path guide gaskets 200 that are formed on the separator main body 100.

The separator main body 100 is formed in a plate shape as same as a conventional separator. Further, a first surface of the separator main body 100 forms a reaction surface 100a and a second surface of the separator main body 100 forms a cooling surface 100b. In addition, a membrane electrode assembly and a gas diffusion layer are laminated on a center portion of the separator main body 100 on the basis of a longitudinal direction to which the reaction gas or the coolant flows, so that a reaction area 110 on which air and hydrogen that are the reaction gases react is formed. Further, a pair of manifold areas 120 through which multiple manifolds 121a to 121f to which the reaction gas or the coolant is introduced or discharged pass, respectively, are formed on opposite sides of the reaction area 110. In addition, a pair of diffusion areas 130 configured to diffuse the flow of the reaction gas or the coolant are formed between the reaction area 110 and the pair of manifold areas 120.

For example, in the pair of manifold areas 120 that are formed on the opposite sides of the reaction area 110, the multiple manifolds 121a to 121f to which the reaction gas or the coolant is introduced or discharged are formed by penetrating the pair of manifold areas 120.

At this time, the multiple manifolds 121a to 121f that are formed on the manifold areas 120 are classified into the manifolds 121d and 121c to which hydrogen that is the reaction gas is introduced or discharged, the manifolds 121a and 121f to which air that is the reaction gas is introduced or discharged, and the manifolds 121b and 121e to which the coolant is introduced or discharged.

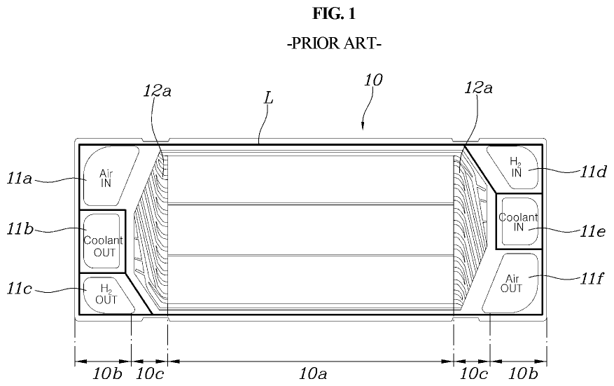

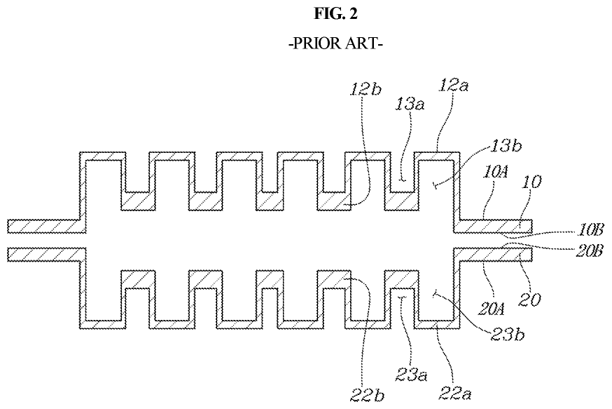

In addition, a sealing line (“L” in FIG. 1) that surrounds the reaction area 10a and each of the manifolds 11a to 11f, which is illustrated in FIG. 1, is formed. At this time, the sealing line is formed as a sealing gasket formed by injecting a rubber material. The sealing gasket is formed by injecting ethylene propylene diene monomer (EPDM) or fluoro elastomers.

Meanwhile, the multiple flow path guide gaskets 200 are formed on the diffusion areas 130 of the separator main body 100, and diffuse the reaction gas and the coolant that are introduced from the manifolds 121a, 121d, and 121e that are at inlet sides, thereby allowing the reaction gas and the coolant to flow to the reaction area 110. Further, the multiple flow path guide gaskets 200 form multiple diffusion flow paths that collect the reaction gas and the coolant discharged from the reaction area 110 and allow the reaction gas and the coolant to flow to the manifolds 121b, 121c, and 121f at outlet sides.

The flow path guide gaskets 200 include: flow path guide gaskets 210 for the reaction gas, the flow path guide gaskets formed on the pair of diffusion areas 130 among the reaction surface 100a of the separator main body 100 and configured to guide diffusion flow of the reaction gas; and flow path guide gaskets 220 for the coolant, the flow path guide gaskets formed on the pair of diffusion areas 130 among the cooling surface 100b of the separator main body 100 and configured to guide diffusion flow of the coolant.

The flow path guide gaskets 210 for the reaction gas are configured to guide the diffusion flow of the reaction gas. As illustrated in FIG. 3A, in the reaction surface 100a of the separator main body 100, multiple flow path guide gaskets 210 for the reaction gas are formed between the reaction area 110 and the manifold 121a to which the reaction gas is introduced among the multiple manifolds, and are formed between the reaction area 110 and the manifold 121f to which the reaction gas is discharged among the multiple manifolds.

In addition, the flow path guide gaskets 220 for the coolant are configured to guide the diffusion flow of the coolant. As illustrated in FIG. 3B, in the cooling surface 100b of the separator main body 100, multiple flow path guide gaskets 220 for the coolant are formed between the reaction area 110 and the manifold 121e to which the coolant is introduced among the multiple manifolds, and are formed between the reaction area 110 and the manifold 121b to which the coolant is discharged among the multiple manifolds.

At this time, as illustrated in FIG. 4, the diffusion areas 130 of the separator main body 100 may be formed to be flat.

Since the flow path guide gaskets 210 for the reaction gas that are for the diffusion flow of the reaction gas and the flow path guide gaskets 220 for the coolant that are for the diffusion flow of the coolant are independently formed on the reaction surface 100a and the cooling surface 100b, respectively, a shape of the flow path guide gaskets 210 for the reaction gas and a shape of the flow path guide gaskets 220 for the coolant are freely designed. Therefore, the shape of the flow path guide gaskets 210 for the reaction gas and the shape of the flow path guide gaskets 220 for the coolant are not limited to a specific shape.

However, in order to improve the diffusivity of the reaction gas or the coolant and to maintain uniform surface pressure at the diffusion areas 130 when the fuel cell stack is laminated, the flow path guide gaskets 210 for the reaction gas and the flow path guide gaskets 220 for the coolant may be continuously formed from the manifolds 121a to 121f to the reaction area 110.

In addition, an interval between the flow path guide gaskets 210 for the reaction gas adjacent to each other may be designed to become uniformly widened to the reaction area 110 from the manifolds 121a and 121f to which the reaction gas is introduced or discharged.

Similarly, an interval between the flow path guide gaskets 220 for the coolant adjacent to each other may be designed to become uniformly widened to the reaction area 110 from the manifolds 121e and 121b to which the coolant is introduced or discharged.

Meanwhile, since the flow path guide gaskets 210 for the reaction gas and the flow path guide gaskets 220 for the coolant do not requires airtightness, various materials capable of being formed by injecting may be applied. For example, the flow path guide gaskets 210 for the reaction gas and the flow path guide gaskets 220 for the coolant may be formed by injecting a rubber material onto a surface of the separator main body 100. At this time, a rubber material that is the same type material of the sealing gasket forming the sealing line may be used to the flow path guide gaskets 210 for the reaction gas and the flow path guide gaskets 220 for the coolant. Preferably, the flow path guide gaskets 210 for the reaction gas and the flow path guide gaskets 220 for the coolant are formed by injecting the EPDM or the fluoro elastomers.

For example, as illustrated in FIG. 4, when the pair of separator main bodies, that is, the cooling surface 100b of the cathode separator main body 100 and a cooling surface 300b of an anode separator main body 300 may be disposed to be facing each other, a diffusion flow path to which air that is the reaction gas flows is formed on the reaction surface 100a of the cathode separator main body 100 by the flow path guide gaskets 210 for the reaction gas. Further, between the cooling surface 100b of the cathode separator main body 100 and the cooling surface 300b of the anode separator main body 300, a diffusion flow path to which the coolant flows is formed by the flow path guide gaskets 220 for the coolant.

In addition, on a reaction surface 300a of the anode separator main body 300, a diffusion flow path to which hydrogen that is the reaction gas flows is formed by flow path guide gaskets 310 for the reaction gas. At this time, another flow path guide gaskets for the coolant may be formed on the cooling surface 300b of the anode separator main body 300. Otherwise, without forming additional flow path guide gaskets for the coolant, only the flow path guide gaskets 220 for the coolant formed of the cooling surface 100b of the cathode separator main body 100 may face and be in contact with the cooling surface 300b of the anode separator main body 300.

Meanwhile, additional flow path guide gaskets for the coolant may not be formed on the separator main body, and a diffusion flow path to which the coolant flows may be formed by performing a forming process that bends the separator main body.

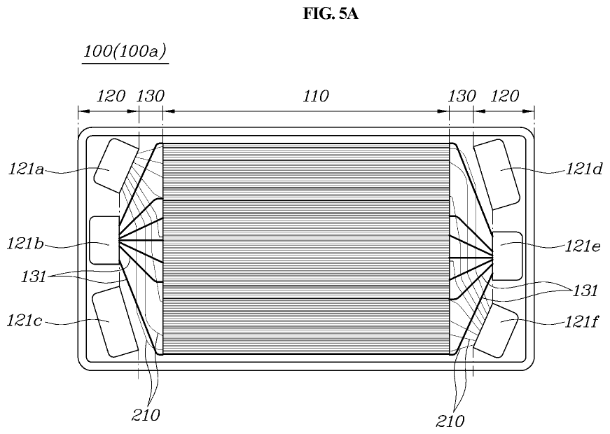

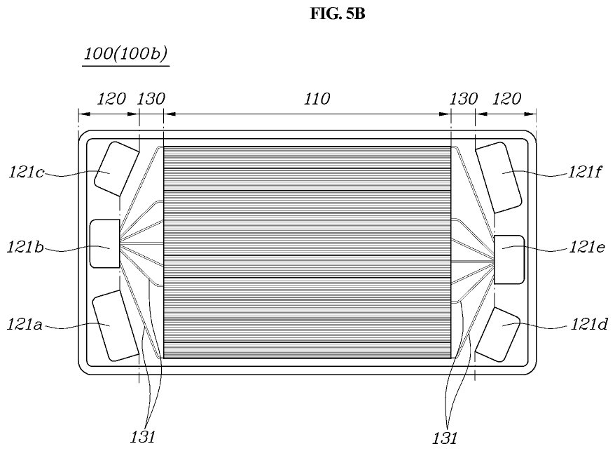

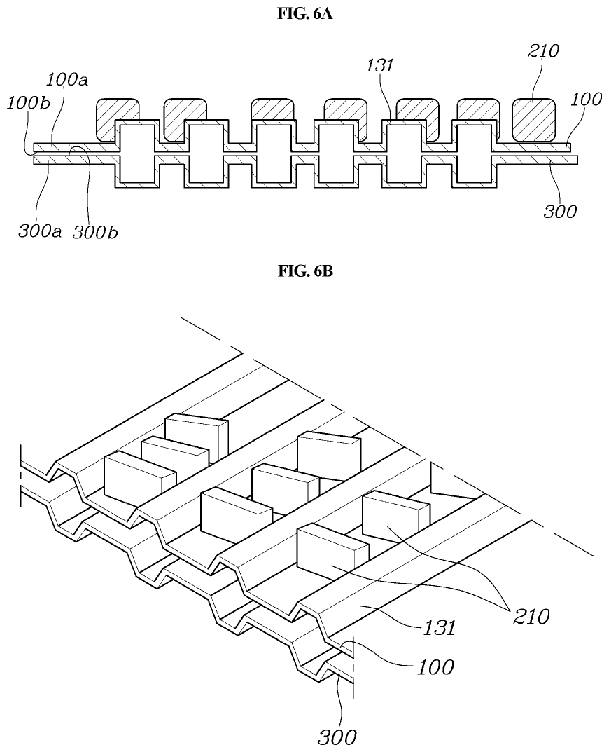

FIG. 5A is a view illustrating the reaction surface of the separator for the fuel cell according to another exemplary embodiment of the present invention, FIG. 5B is a view illustrating the cooling surface of the separator for the fuel cell according to another exemplary embodiment of the present invention, FIG. 6A is a cross-sectional view illustrating the diffusion area of the separator for the fuel cell according to another exemplary embodiment of the present invention, and FIG. 6B is a partial cross-sectional perspective view illustrating the diffusion area of the separator for the fuel cell according to another exemplary embodiment of the present invention.

As the same as the separator for the fuel cell described above, the separator for the fuel cell the separator main body 100 and the multiple flow path gaskets 200. However, the multiple flow path gaskets 200 formed on the separator main body 100 do not form additional flow path guide gaskets 220 for the coolant, and only form the flow path guide gaskets 210 for the reaction gas.

To this end, in the diffusion areas 130 of the separator main body 100, multiple coolant channels 131 that protrude toward the reaction surface 100a and are formed in a groove shape to the cooling surface 100b so that the coolant flows toward the cooling surface 100b are formed. Further, the multiple coolant channels 131 are formed between the reaction area 110 and the manifold 121e to which the coolant is introduced among the multiple manifolds, and are formed between the reaction area 110 and the manifold 121b to which the coolant is discharged among the multiple manifolds.

Further, as illustrated in FIG. 6B, each of the coolant channels 131 may be continuously formed to the reaction area 110 from the manifolds 121e and 121b to which the coolant is introduced or discharged.

In addition, as illustrated in FIG. 6B, each of the flow path guide gaskets 210 for the reaction gas formed on the reaction surface 100a may be formed from the manifolds 121a and 121f to the reaction area 110, and may be discontinuously formed at a portion that is in contact with the coolant channels 131.

At this time, it is preferable that an interval between the coolant channels 131 that are adjacent to each other may be designed to become uniformly widened as the coolant moves from the manifolds 121e and 121b to the reaction area 110.

In addition, although the flow path guide gaskets 210 for the reaction gas adjacent to each other are discontinuously formed, an interval between the flow path guide gaskets 210 for the reaction gas adjacent to each other may be designed to become uniformly widened to the reaction area 110 from the manifolds 121a and 121f to which the reaction gas is introduced or discharged.

However, the coolant channels 131 may have a shape that protrudes to the reaction surface 100a of the separator main body 100, and the flow path guide gaskets 210 for the reaction gas may have a shape that is injected on and protrude to the reaction surface 100a of the separator main body 100. Therefore, as illustrated in FIGS. 6A and 6B, a formation height of the flow path guide gaskets 210 for the reaction gas may be formed to be higher than a formation height of the coolant channels 131.

Therefore, as illustrated in FIGS. 6A and 6B, when the pair of separator main bodies, that is, the cooling surface 100b of the cathode separator main body 100 and the cooling surface 300b of the anode separator main body 300 are disposed to be facing each other, a diffusion flow path to which air that is the reaction gas flows may be formed on the reaction surface 100a of the cathode separator main body 100 by the flow path guide gaskets 210 for the reaction gas. Further, between the cooling surface 100b of the cathode separator main body 100 and the cooling surface 300b of the anode separator main body 300, a flow path to which the coolant flows may be formed in which the coolant flows through the coolant channels 131 formed on the cathode separator main body 100 and a space between the cooling surface 100b of the cathode separator main body 100 and the cooling surface 300b of the anode separator main body 300.

Although the present invention has been described with reference to the accompanying drawings and various exemplary embodiments described above, the present invention is not limited thereto but is limited by the following claims. Accordingly, those skilled in the art may variously modify and changes the present invention without departing from the technical spirit of the following claims.

What is claimed is:

1. A separator for a fuel cell, the separator comprising:
a separator main body formed in a plate shape such that a first surface thereof forms a reaction surface and a second surface thereof forms a cooling surface, the separator main body having a reaction area at a center portion thereof, the separator main body formed with multiple manifold areas through which multiple manifolds to which a reaction gas or a coolant is respectively introduced or discharged pass to opposite sides of the reaction area, and the separator main body in which a pair of diffusion areas allowing the reaction gas or the coolant to be diffused are formed between the reaction area and the pair of manifold areas; and
multiple flow path guide gaskets formed on the pair of diffusion areas and configured such that multiple diffusion flow paths that are spread out to the reaction area from at least a pair of the manifolds that are respectively formed on the pair of manifold areas are formed.

2. The separator of claim 1, wherein the flow path guide gaskets are formed on the pair of diffusion areas among the reaction surface of the separator main body, and comprise multiple flow path guide gaskets for the reaction gas formed between the reaction area and one of the manifold to which the reaction gas is introduced among the multiple manifolds and formed between the reaction area and one of the manifold to which the reaction gas is discharged among the multiple manifolds.

3. The separator of claim 2, wherein the diffusion areas of the separator main body are formed to be flat, and
the flow path guide gaskets are formed on the pair of diffusion areas among the cooling surface of the separator main body, and further comprise multiple flow path guide gaskets for the coolant formed between the reaction area and one of the manifold to which the coolant is introduced among the multiple manifolds and formed between the reaction area and one of the manifold to which the coolant is discharged among the multiple manifolds.

4. The separator of claim 3, wherein the flow path guide gaskets for the reaction gas and the flow path guide gaskets for the coolant are continuously formed from the manifolds to the reaction area, respectively.

5. The separator of claim 2, wherein, at the diffusion areas of the separator main body, multiple coolant channels that protrude toward the reaction surface and forms a groove shape are formed between the reaction area and one of the manifold to which the coolant is introduced among the multiple manifolds and formed between the reaction area and one of the manifold to which the coolant is discharged among the multiple manifolds, thereby allowing the coolant to flow toward the cooling surface.

6. The separator of claim 5, wherein the coolant channels are continuously formed from the manifolds to which the coolant is introduced or discharged to the reaction area, respectively, and
the flow path guide gaskets for the reaction gas are respectively formed from the manifolds to the reaction area and are discontinuously formed at portions that are in contact with the coolant channels.

7. The separator of claim 6, wherein a formation height of the flow path guide gaskets for the reaction gas is greater than a formation height of the coolant channels.

8. The separator of claim 1, wherein the flow path guide gaskets are formed by injecting a rubber material on a surface of the separator main body.

9. The separator of claim 8, wherein, on the surface of the separator main body, a sealing gasket is formed by injecting the rubber material such that a sealing line is formed by surrounding the reaction area and each of the manifolds,
wherein the sealing gasket and the flow path guide gaskets are formed by injecting the same type of the rubber material.

10. The separator of claim 9, wherein the sealing gasket and the flow path guide gaskets are formed of ethylene propylene diene monomer (EPDM) or fluoro elastomers.

11. A fuel cell comprising the separator of claim 1.

12. A vehicle comprising a fuel cell of claim 11.
